(19) United States
(12) Patent Application Publication
(10) Pub. No.: US 2007/0210471 A1
(43) Pub. Date: Sep. 13, 2007

(54) METHOD AND DEVICE FOR THE PRODUCTION OF A PLASTIC PREFORM

(75) Inventors: Gerard Denis, Reims (FR); Eric Didier, Remoncourt (FR)

Correspondence Address: BELL, BOYD & LLOYD LLP, P.O. Box 1135, CHICAGO, IL, 60690, US

(73) Assignee: NESTLE WATERS MANAGEMENT & TECHNOLOGY, Issy-les-Moulineaux (FR)

(21) Appl. No.: 11/569,053

(22) PCT Filed: May 10, 2005
(86) PCT No.: PCT/EP05/05038

§ 371 Date: Nov. 13, 2006

(30) Foreign Application Priority Data
May 11, 2004 (EP) 04011159.3

(51) Int. Cl. B29C 47/30; B29C 47/00

(52) U.S. Cl. 264/85; 264/320; 264/323; 425/128; 425/348 R

(57) ABSTRACT

The present invention relates to a process for manufacturing a preform from a semicrystalline amorphous polymer at a slow rate of crystallization, in which:
the said polymer is plasticized at (3) by rapidly raising its temperature to a temperature below the melting point;
the said plasticized polymer is pressed through a die (4);
on leaving the die, the said polymer is swept by a hot dry inert gas (11);
the plasticized polymer is received in a first container (6), while keeping the polymer at the same temperature as the plasticizing temperature in all the steps; and
a die pressing step (13) is carried out in the said first container or in a second container, transferred from the first, with sudden cooling so as to obtain the preform in an amorphous state.

The present invention relates to a process for manufacturing plastic preforms and to the device for implementing the said process.

Current processes for manufacturing preforms are based on the use of crystallized polymers, which are extruded, in order to melt them above their melting point, and are then injected into a mould: this is the usual method of manufacturing plastic preforms. There exists a second method known for manufacturing plastic preforms, in which a crystallized polymer is melted in an extruder and then the said polymer melt undergoes a die pressing step, also called a compression moulding step. There already exist various patents based on this approach, namely the Toyo Seikan Kaisha patent U.S. Pat. No. 6,349,838, the Sacmi patent WO 01/66327 and the Emery L. Valyi patent U.S. Pat. No. 5,762,854. The drawbacks of this second method are that a crystallized polymer is used, which means that a large amount of energy has to be supplied in order to melt it and a conventional extruder is used for the said melting.

The object of the present invention is to develop a process for manufacturing plastic preforms in which energy is saved, as instead of starting with a crystallized polymer, a semicrystalline polymer is used in its amorphous state, having a plasticizing point well below the melting point of the same polymer in its crystalline state. Apart from the energy saving allowed by the process according to the invention, this also makes it possible to spare the polymer used, as it does not require a high shear rate. Moreover, since the polymer is in the amorphous state, it may have a lower intrinsic viscosity and it will therefore make it possible, downstream, during the stretch-blow-moulding step, to facilitate the said step and save further energy.

The present invention relates to a process for manufacturing a preform from a semicrystalline amorphous polymer in the amorphous state at a slow rate of crystallization, in which:
the said polymer is plasticized by rapidly raising its temperature to a temperature below the melting point;
the said plasticized polymer is pressed through a die;
on leaving the die, the said polymer is swept by a hot dry inert gas;
the plasticized polymer is received in a first container, while keeping the polymer at the same temperature as the plasticizing temperature in all the steps; and
a die pressing step is carried out in the said first container, or in a second container, transferred from the first, with sudden cooling so as to obtain the preform in an amorphous state.

The expression “semi-crystalline polymer with a slow rate of crystallization in the amorphous state” is understood to mean a semicrystalline thermoplastic polymer whose isothermal crystallization temperature lies between the glass transition temperature T_{g} and the melting point Tₘ, but well below Tₘ. The term “semicrystalline polymer” is understood to mean a polymer having a degree of crystallinity of around 30%. Polymers that can be used according to the present invention may be all polymers falling within this category. As possible examples of polymers, mention may be made of polyethylene terephthalate (PET), aromatic polyamides (for example MDX6) and polyethylene naphthalate (PEN). Preferably, the process according to the invention applies to PET.

The first step of the process consists in rapidly raising the temperature of the semicrystalline polymer in the amorphous state in order to plasticize the said polymer. This plasticizing step is carried out at a temperature of the polymer between its melting point and the temperature representing the upper limit of the crystallization region. This temperature is generally well below the melting point of the polymer. In the preferred case of PET, this plasticizing temperature is between 220 and 230° C., whereas, in the case of the crystallized polymer, the melting point is around 250° C. and its working region is 280° C. More preferably, the amorphous PET is plasticized at a temperature of around 225° C.

It is important in the process according to the invention to maintain a constant temperature in the following steps so as not to cause isothermal crystallization or decomposition.

It is also important to rapidly plasticize it for the same reasons as explained above. For example, in the case of PET, the temperature rise must be effected over a period of the order of 1 minute. Of course, it is possible to exceed 1 minute, but in no case to exceed 5 minutes.

When the polymer is plasticized, the second step consists in pressing the said polymer through a die. This die is not critical. Preferably, it has numerous cylindrical openings of size and dimensions suitable for the desired result. Thus, strands of plasticized polymer emerge from beneath the die. The reason for this pressing through the die is to produce fine strands, so as to extract the volatile products with a hot dry inert gas. The term “volatile products” is understood to mean both water and aldehydes (acetaldehyde or formaldehyde) and other products. The inert gas used according to the present invention is not critical. For example, this is nitrogen, carbon dioxide or other gases. Preferably, the gas used is nitrogen. The gas is normally introduced hot and dry under a slight pressure. Preferably, the gas is injected at a minimum relative pressure of around 0.2 bar, at a temperature of 220 to 240° C.

The plasticized polymer is pressed through the die with a pressure that is not critical. However, it is unnecessary to provide excessively high pressures. According to the invention it is preferred to operate at a pressure below 100 bar. Preferably, the pressure employed is around 50 bar.

After the plasticized polymer has been swept with an inert gas, the said polymer is received in a container. In this case, there are two possibilities.

The first consists in carrying out the die pressing in the same container, subsequently cooling from the plasticizing temperature down to a temperature of around 50° C. below the glass transition temperature. The material used for the said container must have a low thermal inertia and the container itself must have a small thickness, so as to allow rapid cooling. The material of the container is a thermal conductor. Preferably, the material is a metal alloy, for example a copper-beryllium alloy.

The second solution consists in transferring the polymer from the first container to a second container in which the die-pressing is carried out, subsequently cooling it from the plasticizing temperature to a temperature of around 50° C. below the glass transition temperature. In this case, the material used for the second container may differ from that of the container for the previous solution. As regards the material of the first container in this case, it is a metal container, for example made of steel or aluminium.

In both cases, after the die pressing, the plasticized polymer is very rapidly cooled over a period of around 1 minute, for example between 30 and 180 seconds.

Of course, the process according to the invention makes it possible to manufacture both preforms weighing a few grams and preforms weighing a few tens of grams. The abovementioned conditions remain valid both for small preforms and for larger preforms.

The present invention also relates to a device for implementing the process described above, the said process comprising:
a chamber for plasticizing the semicrystalline polymer in its amorphous state;
means for heating and regulating the said chamber, placed around it;
means for feeding the said chamber with polymer;
a die beneath the plasticizing chamber;
means above the said chamber for pushing the plasticized polymer through the die;
an inflow of inert gas beneath the die and a device for drying and heating the gas;
a container for receiving the plasticized polymer;
a rotary disc comprising a plurality of containers; and
a die-pressing punch for forming the preform.

It is possible to envisage, as device according to the invention, an apparatus allowing the production of between 1000 and 10 000 preforms per hour. The consumption of polymer ranges from around 100 kg to more than 1 tonne per hour.

The heating and regulating means may be electrical, or any other means known in the prior art.

The feed with amorphous granules is provided by a conventional hopper system and a distribution ring, or any other feed means. The means for pushing the plasticized polymer through the die consist of a thrust cylinder. The disc generally has around 10 to 100 containers. It rotates at a speed of between 0.1 and 15 revolutions per minute. The die-pressing punch is actuated by a die-pressing cylinder, the speed of which is matched to the speed of rotation of the disc.

As already mentioned above, two solutions for the device may equally well be envisaged. The first consists in directly filling the container in which the die pressing will be carried out, and the second consists in providing a first, transfer container and then a second container in which the die pressing will be carried out. These two solutions will be better explained below with reference to the drawings, in which:

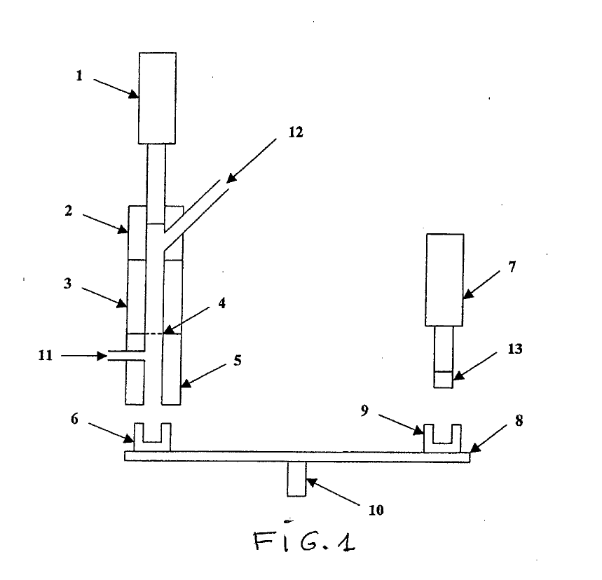

FIG. 1 is a schematic representation of the process according to the invention in the first embodiment;

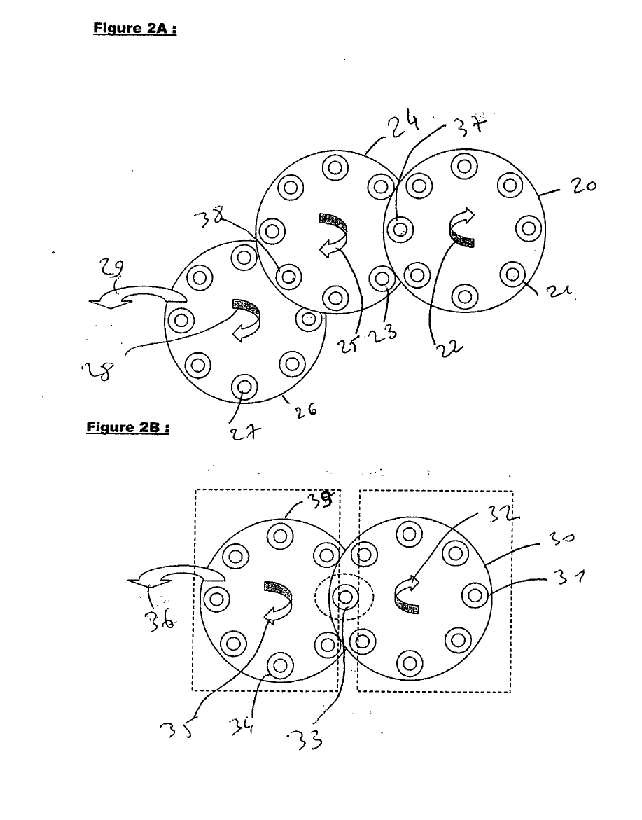

FIG. 2A is a schematic representation of the device according to the invention in one industrial embodiment; and

FIG. 2B is a schematic representation of the device according to the invention in a second industrial embodiment.

In these embodiments, PET will be taken as example. The granules of polymer in an amorphous state arrive via the duct (12) into the plasticizing chamber (3). The feed block (2) is used to isolate the heating chamber (3) so as to plasticize the polymer at the last moment. The thrust cylinder (1) is used to push on the polymer to be plasticized. The die (4) has numerous small holes and emerges in the chamber (5) for extracting the volatile products, the said chamber including an inlet for inert gas (11). The container (6) receives the plasticized polymer and the rotary disc (8) brings the container beneath the punch (13) of the die-pressing ram (7).

The method of operating the device is as follows. The amorphous PET granules arrive via the duct (12) and are heated in the chamber (3) to 220° C. thanks to the regulation of this chamber. What is required is for the layer close to the die (4) to be well plasticized, whereas the layer above needs only to have started to be plasticized. The thrust cylinder (1) is actuated so as to descend and move the plasticized polymer through the die (4), so as to create numerous strands. The nitrogen (11) strikes these strands and carries away or extracts the volatile compounds. The plasticized polymer drops into the container (6) and the thrust cylinder (1) rises, in order to fill the chamber and the next container. The previously filled container (9) is at the moment when the container (6) is being filled beneath the die-pressing ram, and the punch (13) descends in order to manufacture the preform and to cool it by means that are not shown. The disc (8) rotates about its axis (10) and thus makes it possible to manufacture preforms continuously.

In the embodiment of the device according to the invention shown in FIG. 2A, there is a compression plasticization wheel (20) rotating in the direction of the arrow (22). This wheel has 8 containers (21) for recovering the plasticized polymer. Above these containers there are 7 plasticizing heads, such as the one shown in FIG. 1, but these are not shown in the present figure. The transfer wheel (24), rotating in the direction of the arrow (25), allows the plasticized polymer to be transferred onto the compression forming wheel (26). The latter rotates in the direction of the arrow (28).

The operation of the device is as follows: each plasticizing head delivers for example 1 g of amorphous PET into each container (21), which will amount to 7 g per container. Of course, it is always necessary to consider that the 3 wheels (20, 24, 26) are rotating. As regards the container located at (37), this is emptied into a new container (23) and the transfer wheel (24) brings this container into the position (38). From this position, the container is emptied into a new container (27) and the plasticized polymer is then die-pressed by the head (7, 13) of FIG. 1. the containers are emptied either by a gear pump or by a piston. Provided on this last wheel (26) are 8 die-pressing heads which rotate with this last wheel (26). The preform thus obtained is rapidly cooled by means (not shown) and is ejected at (29).

FIG. 2B is a simplification of FIG. 2A; there is a compression plasticization wheel (30) that rotates in the direction of the arrow (32). This wheel has 8 containers (31) for recovering the plasticized polymer. Placed above these containers are 7 plasticizing heads, like the one shown in FIG. 1, but not being shown in the present figure. The transfer wheel of FIG. 2A is omitted and, at (33), the container is emptied into a container (34) and then passes directly onto the compression forming wheel (39), which rotates in the direction of the arrow (35).

The operation of the device is as follows: each plasticizing head delivers for example 1 g of amorphous PET into each container (31), which amounts to 7 g per container. Of course, it is always necessary to consider that the 2 wheels (30, 39) are rotating. As regards the container located at (33), this is emptied into a new container (34) and the plasticized polymer is then die-pressed by the head (7, 13) of FIG. 1. Provided on this latter wheel (39) are 8 die-pressing heads which rotate with this latter wheel (37). The preform thus obtained is rapidly cooled by means (not shown) and is ejected at (36).

### EXAMPLE 1

PET having an intrinsic viscosity of around 0.60 dl/g was used. This was brought into a plasticizing chamber regulated to 225° C. The polymer was swept with dry nitrogen heated to between 225 and 240° C., and 7 g of plasticized polymer were deposited in the container. The disc rotated at 12 revolutions per minute; it had 20 containers and allowed 14 400 preforms to be manufactured per hour. The preforms thus produced were used to make 33 cl containers.

1. Process for manufacturing a preform from a semicrystalline amorphous polymer in an amorphous state at a slow rate of crystallization, comprising:
plasticizing the polymer by rapidly raising its temperature to a temperature below the melting point;
pressing a plasticized polymer through a die;
on leaving the die, exposing the polymer to a hot dry inert gas;
the plasticized polymer is received in a first container, while the polymer is maintained at the same temperature as the plasticizing temperature in all the steps; and
performing a die pressing step in the first container, or in a second container, transferred from the first container, with a sudden cooling so as to obtain the preform in an amorphous state.

2. Process according to claim 1, wherein the amorphous polymer is selected from the group consisting of PET, aromatic polyamides, and PEN.

3. Process according to claim 1, wherein the plasticizing step is carried out at a temperature of the polymer between its melting point and a temperature representing an upper limit of the crystallization region.

4. Process according to claim 3, wherein the polymer is PET and the plasticizing temperature is between 220 and 230° C.

5. Process according to claim 1, wherein the plasticizing step is performed over a period of around one minute.

6. Process according to claim 1, wherein the polymer is pressed through a die having numerous cylindrical openings that are identical in size and dimensions.

7. Process according to claim 1, wherein the plasticized polymer is pressed at a pressure below 100 bar.

8. Process according to claim 7, wherein the polymer is pressed at a pressure of around 50 bar.

9. Process according to claim 1, wherein on leaving the die, the polymer is exposed to a gas selected from the group consisting of nitrogen and carbon dioxide.

10. Process according to claim 9, wherein the gas is nitrogen and introduced at a relative pressure of around 0.2 bar.

11. Process according to claim 1, wherein the die-pressing is performed in the first container, with subsequent cooling from the plasticizing temperature down to a temperature of around 50° C.

12. Process according to claim 1, wherein the polymer is transferred from the first container to a second container in which the die-pressing is preformed, with subsequent cooling from the plasticizing temperature down to a temperature of around 50° C.

13. Process according to claim 1, wherein the cooling is carried out over a period of about one minute.

14. A device comprising:
a chamber for plasticizing a polymer;
means for heating the chamber;
means for feeding the chamber with the polymer;
a die beneath the chamber;
means above the chamber for pushing a plasticized polymer through the die;
an inflow of inert gas beneath the die;
a container for receiving the plasticized polymer;
a rotary disc comprising a plurality of containers; and
a die-pressing punch for forming a preform.

14. Process according to claim 12, wherein the cooling is carried out over a period of around one minute.

15. Process for manufacturing a perform comprising the steps of:
plasticizing a polymer by rapidly raising its temperature to a temperature below its melting point;
exposing the plasticized polymer to a hot dry inert gas as it exits the die;
placing the plasticized polymer in a first container, while maintaining the plasticized polymer at the same temperature as the plasticizing temperature; and
conducting a die pressing step in the first container, while cooling the plasticized polymer so as to obtain a preform.
